(19) United States
(12) Patent Application Publication
(10) Pub. No.: US 2008/0190840 A1
(43) Pub. Date: Aug. 14, 2008

(54) Microfluidic Device with at Least One Retaining Device

(75) Inventors: Jan Eickhoff, Straubenhardt (DE); Patrick Mueller, Bad Peterstal (DE); Jose Angel Mora-Fillat, Ettlingen (DE); Karsten Kraiczek, Waldbronn (DE); Kevin Killeen, Woodside, CA (US); Hongfeng Yin, Cupertino, CA (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: AGILENT TECHNOLOGIES INC., Palo Alto, CA (US)

(21) Appl. No.: 11/547,696

(22) PCT Filed: Feb. 3, 2005
(86) PCT No.: PCT/EP05/50473

§ 371 Date: Aug. 7, 2007

Related U.S. Application Data
(60) Provisional application No. 60/582,519, filed on Jun. 24, 2004.

(51) Int. Cl. B01D 35/00; B32B 37/00; B01J 19/12; B29C 39/02

(52) U.S. Cl. 210/497.01; 210/483; 204/157.15; 156/60; 264/299

(57) ABSTRACT

A microfluidic device comprising at least one inlet port, at least one flow path coupled to the inlet port, and at least one fluid separation element coupled to the flow path, wherein the fluid separation element comprises a packing material and is adapted for separating different components of a fluid, wherein the microfluidic device comprises at least one retaining device for keeping the packing material of the fluid separation element fixed in place and protecting the microfluidic device from debris polluting the analyte.

### BACKGROUND ART

The present invention relates generally to microfluidic laboratory technology for chemical, physical, and/or biological analysis, separation, or synthesis of substances on a microfluidic device. It relates in particular to microfluidic devices for component separation in a fluid. More specifically, the invention relates to microfluidic chromatographic and electrophoretic column filters and/or retaining devices for microfluidic devices. Besides this, the invention relates to methods of producing microfluidic devices.

Within a typical cell, for example, there are several thousand proteins with different functionality. A number of techniques have been suggested for analyzing these cellular proteins, such as two-dimensional electrophoresis or liquid chromatography followed by mass spectrometry.

There are many chromatographic techniques known in the art, such as reversed phase liquid chromatography, isocratic liquid chromatography, gradient liquid chromatography, and other. Chromatographic separation occurs when a mobile phase carries sample molecules through a chromatography bed (stationary phase) where sample molecules interact with the stationary phase surface.

Efforts in the field to miniaturize separation systems are high because such miniaturized systems generally provide improved analytical performance characteristics. They have a relatively simple construction and seem to be, in theory, inexpensive to manufacture. In practice, such miniaturized microfluidic devices have to fulfill a variety of requirements such as low dead volume and short flow paths with a cross section as constant as possible, high durability, and invariable quality. To achieve the requirements, a precise and consequently relatively expensive production process has to be implemented, for example the stationary phase has to be inserted into the microfluidic device as densely as possible. Devices for executing separation processes are for example described in the US 2003/0017609 A1 Liquid chromatography techniques usually need a pressure-driven flow of the liquid phase through the stationary phase. A mechanical or other type of pump is typically employed to generate pressure to drive a sample through the column. Because of an enormous pressure drop inside the packed columns, relatively high pressures are needed to elute the sample. During sample introduction and/or analysis undesired displacement of the stationary phase might take place. To diminish these problems, microfluidic devices are suggested, for example as described in the US 2003/0150792 A1, U.S. Pat. No. 6,267,884 B1, US application (unpublished, Attorney Docket No.: 10030363, filed Apr. 9, 2004), or in the WO 01/38865 A1. Nevertheless, it can be seen that in spite of these efforts, the suggested solutions are not sufficient.

### DISCLOSURE OF THE INVENTION

It is an object of the invention to provide an improved miniaturized microfluidic device. Further, it is an object of the invention to provide an improved production process for microfluidic devices. The object is achieved by the independent claims. Preferred embodiments are shown by the dependent claims.

The invention relates to a microfluidic device comprising at least one inlet port, at least one flow path coupled to the inlet port, and at least one fluid separation element coupled to the flow path. The fluid separation element comprises a packing material and is adapted for separating different components of a fluid. The device is characterized by at least one retaining device adapted for retaining the packing material of the fluid separation element.

Embodiments may include one or more of the following. A retaining device is understood in this application as any device and/or design for retaining and/or confining and/or holding the packing material in place inside the microfluidic device. It is to be understood that, throughout this description, wherever the terms closing, sealing, concluding, or alike are used for describing the retaining device, selectively closing, sealing, or concluding, for example by using semi permeable or rather fluid permeable materials, has to be understood. The fluid separation element can comprise a stationary phase comprising the packing material for a liquid chromatography or electrophoresis. The retaining device can hold the packing material that is the stationary phase in place inside the column and can protect the packing material against any contamination, for example caused by particles, e.g. dirt particles originating from wear of preceding analytical equipment in the analytical flow path and/or improperly prepared sample. The retaining device can be employed for any kind of microfluidic device. In preferred embodiments, the fluid separation element comprises a column that is adapted to execute a liquid chromatography process and contains a grained or rather particulate and/or porous material.

Embodiments may also include one or more of the following. The grained material can be jammed, held in place by a frit, bonded, glued, heat-treated, decomposed, and/or irradiated. Advantageously, this can change the structure, condition and/or the state of the grained material for forming the retaining device. Preferred the structure, condition, and/or the state of the grained material, in particular glass, silica gel or polymeric powder, can be changed within the fluid separation element inside the microfluidic device. The grained material can be wrapped with and/or be adjacent to a porous monolithic polymeric material realizing the retaining device.

Embodiments may include one or more of the following. The flow path of the microfluidic device can comprise at least one narrowing for jamming the packing material. The packing material forms a plug up at the narrowing. The packing material is thus fixed within the column and protected against undesired displacing or contamination with solid material. The packing material comprises particles with an average particle size. The diameter, in particular the maximal size of the cross section, of the flow path is reduced at the narrowing at least to the minimal particle size of the grained material multiplied by 5, in particular by 2, preferably by a value larger than 0.1 for inducing the jamming of the packing material and shaping the plug-up. Instead of the analytical material of the packing material a filtering material, for example glass beads, silica gel beads or a polymeric powder can be plugged-up. Preferred the flow path comprises at least two parallel-connected redundant narrowings. In case of any clogging of any one of the narrowings, the other one can still guarantee the function of the microfluidic column coupled to the narrowings.

Embodiments may also include one or more of the following. Advantageously the microfluidic device comprises an opening for filling the material into the device. The opening can be coupled to the fluid separation element, for example approximately in the middle of the fluid separation element. The fluid separation element can be concluded at two end points by two series-connected narrowings. The narrowings are series-connected via the fluid separation element. The narrowings induce a fluid-permeable plug up of the packing material inside the fluid separation element realizing a filter or rather the retaining device for keeping the packing material of the fluid separation element in place. After packing the fluid separation element, the opening can be closed by a suitable closure. Preferred the opening realizes the inlet port of the microfluidic device. The packing material can be packed, e.g. filled, into the fluid separation element through the opening. Advantageously the opening comprises a conically formed portion. The portion can be an integral part of the microfluidic device or inlayed into the inlet port after filling the packing material into the fluid separation element. The packing material can form a plug up at the portion for closing a first end point of the fluid separation element. A second end point of the fluid separation element can be sealed for example by one single narrowing or by at least two parallel-connected redundant narrowings. Possibly a pair of at least two parallel-connected redundant narrowings can be series-connected via the fluid separation element or rather the final end points of the fluid separation element.

Embodiments may also include one or more of the following. The retaining device can be realized by a microfluidic sieve, in particular comprising a structured plate having micro-holes, a porous polyimide, and/or a sheet-calendered foil. The sample can pass the sieve, but the packing material cannot. As an additional external part, the sieve can be firmly pressed against and/or bonded, sticked, glued, adhered, or alike to the microfluidic device and hold the packing material in place without affecting the function of the stationary phase within the fluid separation element. As well, the sieve can protect the microfluidic device from particles that might contaminate it. The relatively large opening, needed for packing the fluid separation element, can be easily covered by the sieve.

The invention further relates to a method for producing a microfluidic device with a retaining device filter. Firstly, a grained material is filled through an opening of the microfluidic device into a fluid separation element, for example a column, of the microfluidic device. After that, the fluid separation element is sealed at least at two end points and subsequently closed, for example by sealing or by using a cover. Embodiments may include one or more of the following. The opening can be dimensioned as large as needed for filling the packing material into the fluid separation element of the microfluidic device. The packing material does not have to be transported through ports and flow paths coupled to the fluid separation element. The ports and the flow paths can be dimensioned according to the specifications of the microfluidic processes to be executed with the microfluidic device. Preferably, microfluidic flow paths and ports with a diameter of less than 5 microns are consequently too narrow for transporting packing material known in the art for packing the fluid separation element. The condition of the grained material can be changed in situ or rather within the device by a fritting, bonding, gluing, decomposing, heat-treating, chemical treating, and/or irradiation process for immobilizing the packing material or rather the stationary phase of the fluid separation element. Preferably, only the material close to the end points of the fluid separation element is treated for this. Alternatively, the material can just be jammed at the end points for closing the fluid separation element or rather for realizing the retaining device.

The invention further relates to another method for producing a microfluidic device with a retaining device. Firstly, an analytical material is filled through an opening of the microfluidic device into a fluid separation element, for example a column, of the microfluidic device. After that, a sealing or rather a filtering material is filled through the opening for sealing the fluid separation element. Subsequently, the structure and/or the state of the filtering material are changed by a photo- or thermally induced polymerization process. Embodiments may include one or more of the following. Advantageously, the structure and/or the state of the filtering material are changed by exposure to ultra violet radiation. The changed material builds a retaining device or rather a filter for closing the fluid separation element of the microfluidic device. The filtering material can be easily applied in a liquid state. The material is changed by the photo polymeric process to form a porous solid monolithic filtering material.

Embodiments may also include one or more of the following. As a first step, a fluid separation element, for example a liquid chromatography column, of the device is packed through an opening with a packing material. Subsequently, a grained polymeric material is filled into the opening. Finally, the structure and/or the state of the grained polymeric material are changed by a thermal treatment. Advantageously, the melting point of the polymeric material is lowered at the surface by activating the surface with ultra violet radiation before filling the material into the opening. Preferably, Polyetheretherketone (PEEK) is used for this process. The polymer surface can be activated in such a way that the surface material melts at temperatures as low as 100° C. The material can be modified to form a porous monolithic filtering material for sealing the fluid separation element, for example by tempering the whole microfluidic device temperatures as low as at 100° C. The retaining device is formed in situ without endangering other components of the microfluidic device

The invention further relates to another method for producing a microfluidic device with a retaining device. Firstly, grained material that comprises porous beads is filled through an opening of the device. Subsequently, the beads close to the opening are decomposed. Finally, the components of the decomposed beads are adsorbed to adjoining not decomposed beads. They now provide a retaining device for the packing material of the fluid separation element. Flow of the mobile phase is maintained. Embodiments may include one or more of the following. Advantageously, the beads are decomposed and adsorbed by a chemical and/or thermal treatment, in particular by a thermal treatment induced by an infrared laser.

The invention further relates to another method for producing a microfluidic device with a retaining device and a fluid separation element. Firstly, a mixture of two monomers is filled into the fluid separation element. Subsequently, a polymerization process is started. Finally, a component of the polymerized mixture is washed out. This results in a monolithic porous material realizing a stationary phase of the fluid separation element. Due to the in situ polymerization, the monolithic porous material is fixed inside the fluid separation element by a form closure.

### BRIEF DESCRIPTION OF DRAWINGS

Other objects and many of the attendant advantages of embodiments of the present invention will be readily appreciated and become better understood by reference to the following more detailed description of preferred embodiments in connection with the accompanied drawings. Features that are substantially or functionally equal or similar will be referred to with the same reference signs.

FIG. 1 shows a partly top view of a microfluidic device with a microfluidic retaining device comprising three parallel-connected narrowings;

FIG. 2 shows a partly top view of another microfluidic device with another microfluidic retaining device comprising three parallel-connected narrowings;

FIG. 3 shows a partly schematic detailed view of a retaining device with decomposed beads;

FIG. 4 shows a partly schematic top view of a microfluidic device having a microfluidic fluid separation element with two retaining devices;

FIG. 5 shows a schematic top view of a microfluidic device having a microfluidic fluid separation element;

FIG. 6 shows a longitudinal cut of a microfluidic device;

FIG. 7 shows a longitudinal cut of another microfluidic device;

FIG. 8 shows a partly longitudinal cut of another microfluidic device;

FIG. 9 shows a partly cross-sectional view of another microfluidic device;

FIG. 10 shows a partly cross-sectional view of another microfluidic device;

FIG. 11 shows a top view of a plate with micro-holes realizing a filter.

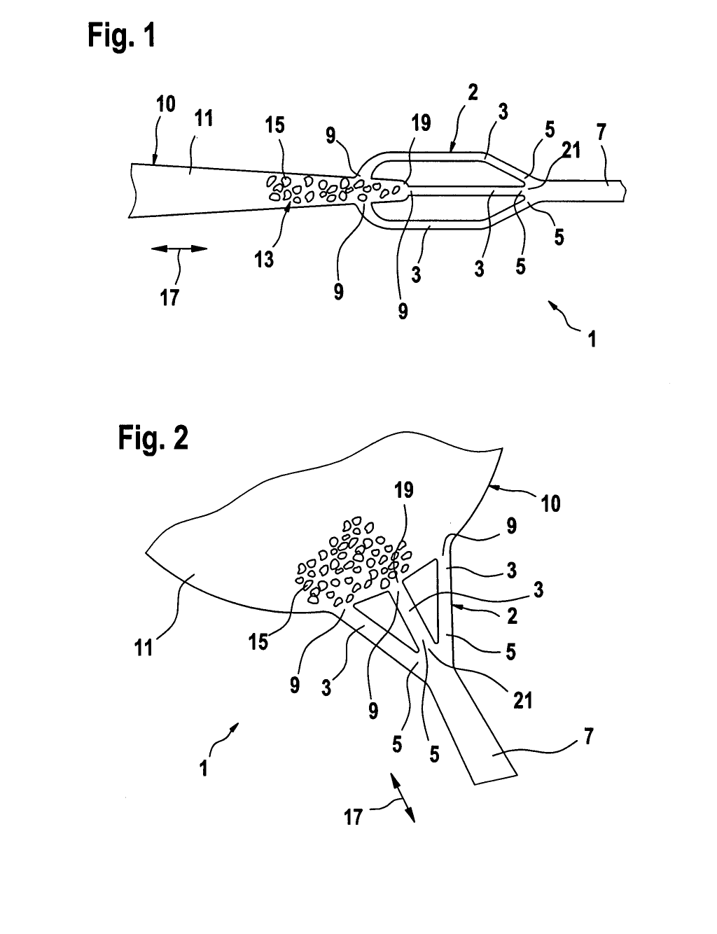

FIG. 1 shows a microfluidic device 1 with a retaining device 2 having three parallel-connected narrowings 3. The parallel-connected narrowings 3 are each coupled at a first end point 5 to a flow path 7 and at a second end point 9 to a fluid separation element 10 comprising in this embodiment a microfluidic column 11.

The retaining device 2 is coupled to the flow path 7 of the microfluidic device 1 and to the microfluidic column 11 for keeping a packing material 13 of the fluid separation element 10 fixed in place and protecting the microfluidic device 1 from debris polluting the analyte. In embodiments, the packing material 13 of the microfluidic column 11 comprises a grained material 15 as indicated in FIG. 1 by curls. The packing material 13 with the grained material 15 realizes a stationary phase for a microfluidic chromatography process. A liquid, for example to be analyzed (mobile phase) or for flushing the microfluidic column 11, can be transported in any direction through the retaining device 2, the flow path 7, and the microfluidic column 11, as indicated by a double arrow 17. The packing material 13 is protected by the retaining device 2 against any undesired displacement.

Two of the parallel-connected narrowings 3 of the retaining device 2 are coupled to the retaining device 2 approximately rectangular to the flow direction—as indicated by the double arrow 17—of the liquid. A third parallel-connected narrowing 3 is coupled in flow direction to the retaining device 2 at a end point 19 of the microfluidic column 11 and arranged in between the other two parallel-connected narrowings 3. The microfluidic column 11 is tapered towards its end point 19.

The retaining device 2 comprises three flow paths coupled at a triple forking 21 to the flow path 7 of the microfluidic device 1. The flow paths of the retaining device 2 are partly parallel to each other. In other embodiments, the flow paths can have any other shape or course. The diameter, in particular the maximal size of the cross section, of the parallel-connected narrowings 3 can vary in embodiments. It is reduced at the narrowings 3 at least to the minimal grain size of the grained material multiplied by 5, in particular by 2, preferably by a value less than 5 and larger than 0.1, possibly by a value less than 3 and larger than 0.5, for jamming the packing material 13 and forming a plug up. The plug up closes the microfluidic column 11 and protects against any undesired displacement of the packing material 13 of the microfluidic column 11. The microfluidic column 11 is closed by self-retaining of the packing material 13. The mobile phase—the liquid to be analyzed—can pass the plugged-up grained material 15 of the microfluidic column 11.

The microfluidic column 11 can be filled up partly or completely with the packing material 13. In embodiments, the plug-up is realized by another material, for example a grained and/or porous filtering material.

FIG. 2 shows another retaining device 2 having substantially the same functionality as described in FIG. 1. Therefore, only the differences are described.

Differing from the retaining device 2 as described in FIG. 1 the routing of the three parallel-connected narrowings 3 is rectilinear radial from the triple forking 21 of the retaining device 2 towards the microfluidic column 11.

Two of the parallel-connected narrowings 3 of the retaining device 2 are coupled to the microfluidic column 11 angular to the flow direction of the liquid—indicated by the double arrow 17. The third parallel-connected narrowing 3 is coupled in flow direction to the microfluidic column 11 and arranged in between the other two parallel-connected narrowings 3. In embodiments the retaining device 2 comprises more or less than 3 parallel-connected narrowings 3 or only a single one narrowing 3.

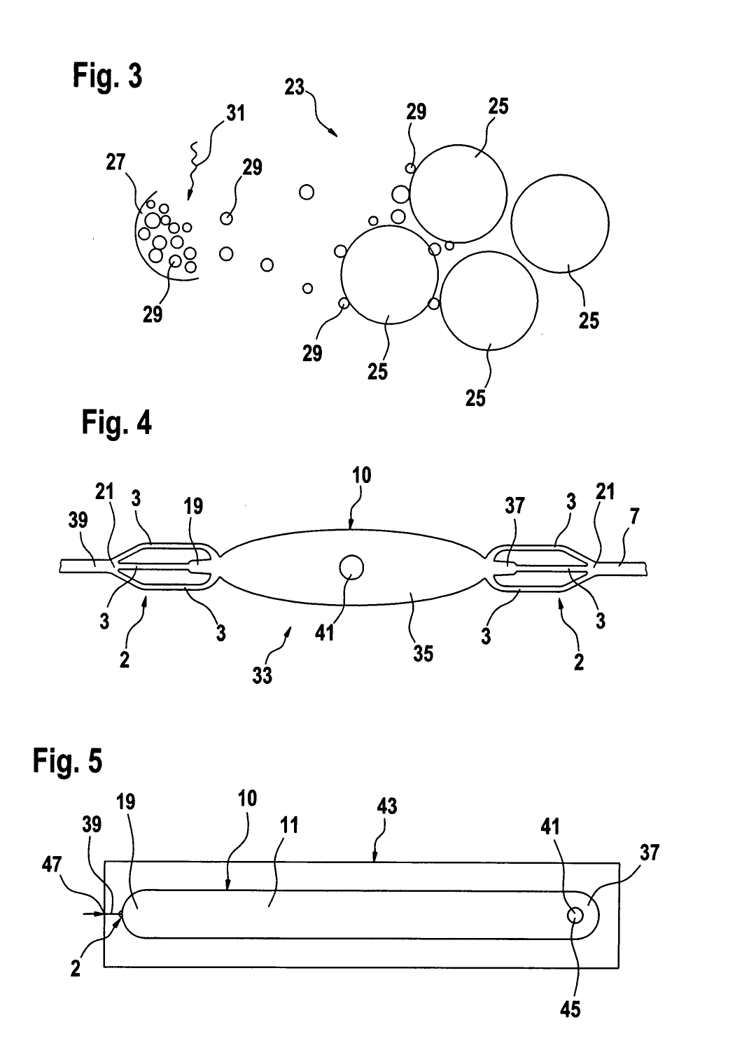

FIG. 3 shows a partly schematic detailed view of a retaining device 23 with beads 25 and decomposed beads 27. The beads 25 comprise a plurality of components 29. In embodiments, the beads 25 comprise adhering components 29. The retaining device 23 comprises the fritted beads 25 and the components 29 of decomposed beads 27 adhering to not decomposed beads 25.

The beads 25 being not decomposed can comprise the same components 29 as the decomposed beats 27 or can comprise another material. In embodiments, the components 29 can also be adhered to the beads 25 comprising the other material.

The beads 27 are decomposed by a chemical and/or thermal treatment as symbolized with an arrow 31 and adsorbed to the beads 25 being not decomposed. In embodiments, the thermal treatment is induced by an infrared laser. The components 29 can be adsorbed to the beads 25 by adhering or by jamming the components 29 in between the not decomposed beads 25.

FIG. 4 shows a partly schematic view of a microfluidic device 33 having a microfluidic fluid separation element 10 with two retaining devices 2 as described in FIG. 1. Therefore, only the differences are described.

Differing from the microfluidic device 1 as described in FIG. 1, the microfluidic device 33 comprises two retaining devices 2 coupled to the fluid separation element 10. In this embodiment, the fluid separation element 10 comprises a column 35 that is tapered on both sides, for example oval-shaped as shown in FIG. 4. The dual tapered column 35 is coupled at a first end point 19 and at a second end point 37 to the retaining devices 2. The retaining devices 2 each are equally coupled to the dual tapered column 35 as described in FIG. 1. The retaining devices 2 with the parallel-connected narrowings 3 are series-connected via the dual tapered column 35. The retaining devices 2 can close the dual tapered column 35 at the end points 19, 37. The packing material 13 of the dual tapered column 35 can be held in place or rather be protected against any undesired displacement by the retaining devices 2.

The dual tapered column 35 is coupled to the flow path 7 and to a flow path 39 via the retaining device 2. The flow paths 7, 39 can be coupled to a microfluidic feeding device and to a laboratory apparatus (both not shown) for analyzing a liquid and/or separating components of the liquid by transporting the liquid through the microfluidic device 33. Microfluidic devices for such purpose are known in the art and therefore not described in detail.

The microfluidic device 33 comprises an opening 41 for filling the packing material 13 into the microfluidic device 33. In embodiments, firstly a filtering material, in particular a grained material, and subsequently a grained analytical material is filled through the opening 41 into the dual tapered column 35. The dual tapered column 35 can be closed at the end points 19, 37 by the filtering material. The rest of the dual tapered column 35 can be filled with the grained analytical material or rather the packing material 13. The condition of the filtering material can be changed to a monolithic porous material near the retaining devices 2 by a fritting, bonding, gluing, decomposing, heat-treating, and/or irradiation process for closing the dual tapered column 35. This process can happen in situ inside the microfluidic device 33. In embodiments, the dual tapered column 35 can be closed without the retaining devices 2 just by the changed material.

FIG. 5 shows a schematic top view of a microfluidic device 43. In this embodiment, the opening 41 of the microfluidic fluid separation element 10 of the microfluidic column 11 is positioned nearby the end point 37 of the microfluidic column 11. After packing the fluid separation element 10 with the packing material 13—not illustrated in FIG. 5—the opening 41 can be closed by a suitable fluid permeable closure or by a treatment of the material inside the fluid separation element as described above. In this embodiment, the opening 41 realizes an inlet port 45 of the microfluidic device 43. The microfluidic column 11 is coupled to a spray tip 47 via the flow path 39 and the retaining device 2 at the end point 19 of the microfluidic column 11. The spray tip 47 can be inserted into a laboratory apparatus for spraying liquid to be analyzed into the apparatus.

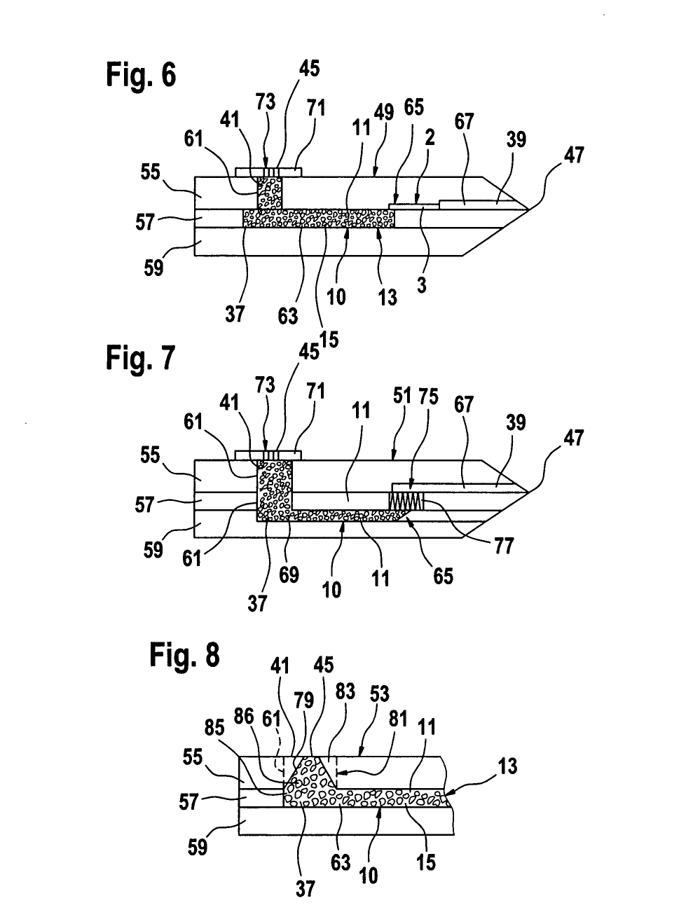

The FIGS. 6 to 8 show longitudinal cuts of different embodiments of microfluidic devices 49, 51, 53. The differences are described by referring to the FIGS. 6 to 8.

The microfluidic devices 49, 51, 53 comprise three layers, a top layer 55, a middle layer 57, and a bottom layer 59. The layers 55, 57, 59 can be laminated. The manufacturing process and the principal construction of a multilayer microfluidic device, for example a microfluidic chip, is known in the art and consequently not described in detail. The layers 55, 57, 59 comprise the different functional elements of the devices 49, 51, 53.

The top layer 55 comprises the opening 41, realized in this embodiment by a through bore 61. The through bore 61 is coupled to the fluid separation element 10, the microfluidic column 11.

The microfluidic device 49 as shown in FIG. 6 comprises the retaining device 2 with the parallel-connected narrowings 3 coupled to the flow path 39. The middle layer 57 comprises the microfluidic column 11. The microfluidic column 11 can be realized by any through hole or groove in the middle layer 57, for example a slit 63, or an through cut long hole in the middle layer 57. The retaining device 2 of the microfluidic device 49 is realized in the top layer 55 of the microfluidic device 49. The parallel-connected narrowings 3 of the retaining device 2 can be realized for example by grooves inserted into the top layer 55 or in the middle layer 57 of the microfluidic device 49. The slit 63 of the middle layer 57 and the grooves inserted in the top layer 55 of the microfluidic device 49 overlap at an overlapping zone 65 for coupling the microfluidic column 11 to the retaining device 2.

The flow path 39 can be realized by a groove 67 having for example the same cross-sectional area as the three parallel-connected narrowings 3 together.

The microfluidic device 51 as described in FIG. 7 comprises a groove 69 in the bottom layer 59 realizing the microfluidic column 11. The microfluidic column 11 is coupled to the opening 41 via the through bore 61 that is also inserted to the middle layer 57 of the microfluidic device 51. The through bore 61 and the microfluidic column 11 can be filled with the grained material 15, the packing material 13 through the opening 41 as described above.

The microfluidic devices 49, 51 as shown in FIGS. 6 and 7 comprise additionally a microfluidic sieve 71 realizing a retaining device 73. In embodiments the retaining device 73 is placed on the outside of the microfluidic devices 49, 51 facing and covering the inlet port 45 or rather the opening 41 of the microfluidic devices 49, 51. In other embodiments, the sieve is bonded, laminated, or alike to the microfluidic devices 49, 51. In embodiments, the sieve 71 is realized by a structured plate having micro-holes, a porous polyimide, and/or a sheet-calendered foil. The sieve 71 is fluid permeable, but not permeable for the grained material 15 of the packing material 13 of the microfluidic column 11 and avoids any undesired displacement of the grained material 15 within the microfluidic devices 49, 51.

The microfluidic device 51 as shown in FIG. 7 comprises a second retaining device 75 having a second microfluidic sieve 77. In embodiments, the second microfluidic sieve 77 is inserted as a separate part in the middle layer 57 of the microfluidic device 51. In another embodiment, the microfluidic sieve 77 is an integral part of the middle layer 57. The second microfluidic sieve 77 can have the same features and function as the microfluidic sieve 71 as described above.

Referring to FIG. 7, the flow path 39 of the top layer 55, the second microfluidic sieve 77 of the middle layer 57, and the microfluidic column 11 of the bottom layer 59 overlap at the overlapping zone 65 for coupling the microfluidic column 11 to the flow path 39 via the second microfluidic sieve 77.

The opening 41 of the microfluidic device 53 as described in FIG. 8 comprises a conically formed portion 79 realizing the inlet port 45 and a retaining device 81 of the microfluidic device 53. In embodiments, the portion 79 can be an integral part of the microfluidic device 53. In preferred embodiments, the conically formed portion 79 is realized by an inlay 83—illustrated with dotted lines. The inlay 83 is inserted in the opening 41 or rather the through bore 61 of the opening 41. The inlay 83 can be inlayed into the opening 41 after filling the packing material into the fluid separation element 10. The packing material can form a plug-up 85 at the portion 79 for closing the end point 37 of the fluid separation element 10. In embodiments, the inlay 83 comprises a filtering material before being inserted in the opening 41 of the microfluidic device 53.

In preferred embodiments, the second column port 79 is filled in situ with the packing material 13 and/or a filtering material 86 being jammed and/or treated as described above for realizing the retaining device 81 or rather the plug-up 85 of the retaining device 81 of the microfluidic device 53. In embodiments, the filtering material 86 comprises a grained material, for example polymeric powder or glass beads or silica gel beads.

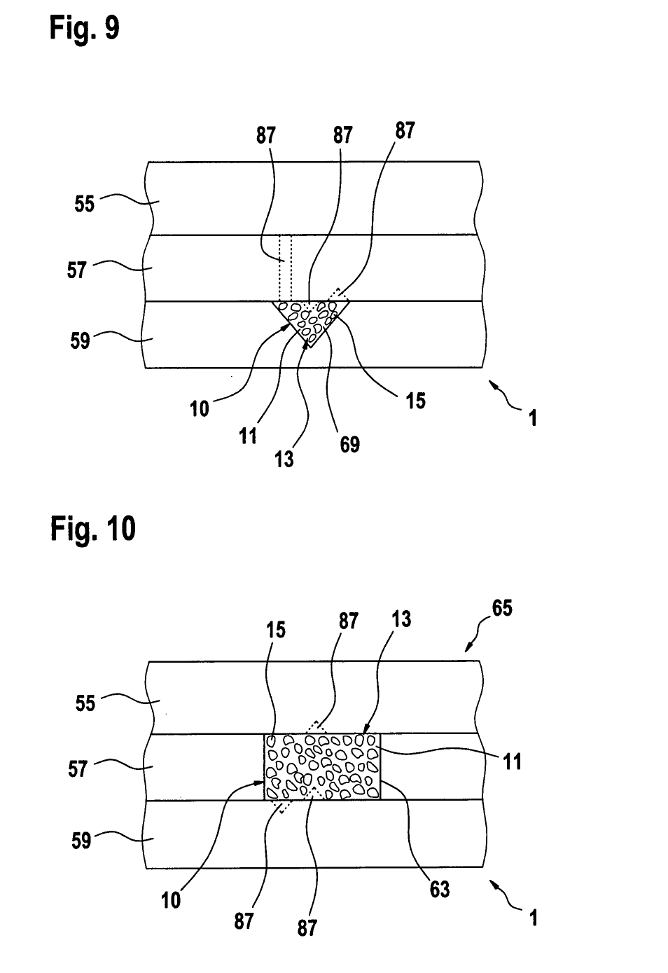

FIGS. 9 and 10 show schematic partly cross-sectional views of different microfluidic devices 1, taken at the cutting over zones 65 of the microfluidic devices 1. The microfluidic devices 1 are of the same kind as the microfluidic devices 49, 51 as described in the FIGS. 6 and 7.

The FIGS. 9 and 10 demonstrate how the fluid separation elements 10 can be coupled to other functional elements 87—drawn with dotted lines. The functional elements 87 can be realized by any kind of groove, depression, slit, and/or fluid path inserted in at least one of the layers 55, 57, 59. For coupling with the fluid separation elements 10, the functional elements 87 overlap with the fluid separation elements 10 of the microfluidic devices 1 in different layers or are implemented in the same layer and coupled directly to the fluid separation element 10. The functional elements 87, for example a flow path, can have a cross-sectional area of less than 5 up to 2500 microns², for example inserted to the layers by a laser or any other suited method. The small cross section forms channels of a possibly low volume, which is advantageous for handling low fluid volumes as usually done in the microfluidic art. The large cross section forms channels with a low fluid resistivity, i.e. a low pressure drop, which is advantageous for certain channel functions, e.g. waste channels. A typical column has a cross-sectional area of 2500 microns². The cross-sectional area of a column can be reduced to a value of less than 100 microns². The average particle size of packing materials known in the art varies between 1.8 and 5.0 microns. Depending on future production processes and available packing materials, smaller dimensions are conceivable.

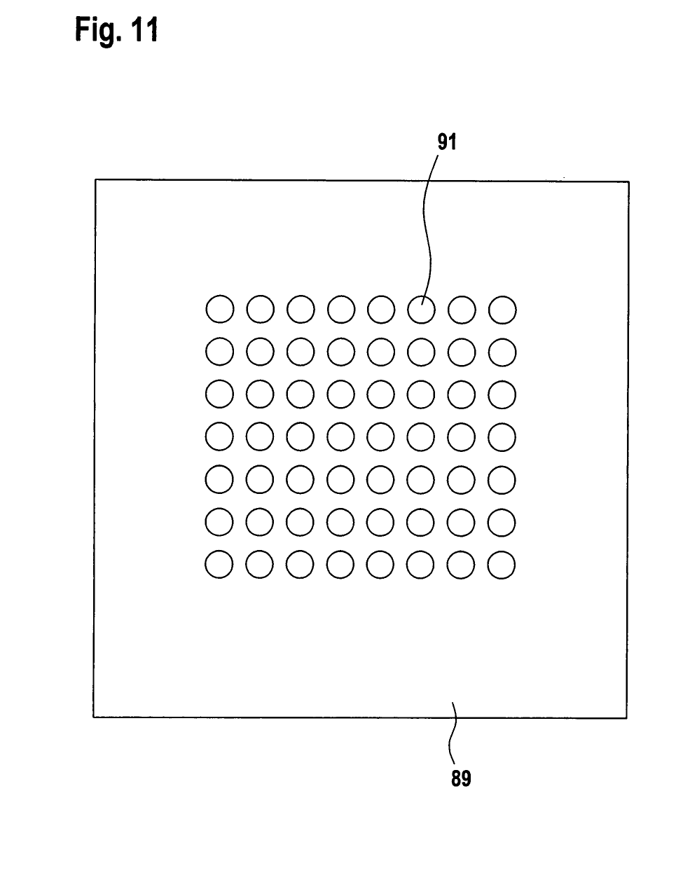

FIG. 11 shows a top view of a structured plate 89 with micro-holes 91 realizing a sieve for closing a fluid separation element 10 of a microfluidic device as described above. The micro-holes 91 can be inserted to the structured plate 89 by laser or any other suited method and can have a diameter of more than 1 micron and less than 25 microns. The micro-holes 91 can be tapered in flow or reverse flow direction. By that, the diameter of the micro-holes 91 diminishes in flow or reverse flow direction. The diameter of the micro-holes 91 is chosen appropriately, preferred comparable or smaller than the packing diameter of the packing material the structured-plate 89 realizes an effective retaining device 2, being not permeable for the grained material 15 of the microfluidic column 11. The micro-plate 89 can be coupled to a rotor of a multi-route-switching valve (not shown) with grooves for connecting and/or switching ports of the microfluidic device 1. Consequently, the micro-plate 89 can cover more than one port of the microfluidic device 1.

In embodiments, the retaining device 2 comprises a monolithic in situ polymerized porous material. The in situ polymerized porous material of the retaining device 2 can be the packing material 13 of the fluid separation element 10. The retaining device 2 and the packing material 13 are joined to one functional unit. The in situ polymerized porous material can be held in place for example by at least one narrowing, at least one curve in the microfluidic column 11, at least one protrusion in the microfluidic column 11. In embodiments, the polymerized porous material is form-closed with the microfluidic device 1.

In embodiments, the packing material 13 is adapted for executing an electrophoresis process, comprising for example a gel.

Referring to the FIGS. 1 to 11 it is described how the microfluidic device 1 or better retaining device 2 can be produced easily.

For producing a microfluidic device 1, grained material 15 can be filled easily through a relative large opening 41 of the microfluidic device 1, 33, 43,49, 51, and/or 53 into a column 11 of the microfluidic device. After that, the column 11 can be closed at least at two end points 19, 37. In embodiments, for realizing a retaining device 2, the grained material 15 can be jammed. In further embodiments, for realizing a retaining device 2, the grained material 15 can be treated with a fritting-, a bonding-, a gluing-, a decomposing-, a heat-treating-, and/or a irradiation-process. Advantageously, these processes can be executed in situ within the microfluidic device 1.

According to embodiments, a packing material 13 can be filled through the opening 41 of the microfluidic device into the column 11 of the microfluidic device. Subsequently, a filtering material 86, for example Polyetheretherketone (PEEK), can be filled through the opening 41 for closing the column 11. Finally, the structure and/or the state of the filtering material 86 can be changed. In embodiments, the structure and/or the state of the filtering material 86 can be changed by a photo polymeric process, for example by using ultra violet radiation and/or by a thermal treatment. In embodiments, the melting point of the grained polymeric material, for example the filtering material 86, is lowered at the surface by modifying the surface using ultra violet radiation. Advantageously in embodiments, the surface-modified grained polymeric material can be tempered at temperatures as low as 100° C., in particular lower, inside the device without damaging any other elements of the device. The surface-modified grained polymeric material melts to a porous fluid permeable monolithic filter that closes the microfluidic column 11 of the microfluidic device. In embodiments, the packing material 13 of the microfluidic column 11 melts completely to form a porous fluid permeable monolithic filter.

In embodiments, the material filled into the microfluidic device comprises beads 25 comprising adhering components 29. Subsequently, beads 27 near the opening 41 can be decomposed, for example by a by a chemical and/or thermal treatment. The thermal treatment can be induced by an infrared laser. Finally, the components 29 of the decomposed beads 27 can be adsorbed to adjoining not decomposed beads 25 for closing the column 11.

In further embodiments, a mixture of two monomers is filled into the fluid separation element 10, and a polymerization process is started. Finally, one component of the polymerized mixture can be washed out. This results in a porous monolithic packing material 13 of the microfluidic column 11 of the microfluidic device. The fluid separation element 10 can be fixed form-closed within the microfluidic device.

In embodiments, the microfluidic device can be designed as a microfluidic chip, for example a chip comprising polymer layers, for example comprising Polyimide. The microfluidic chip can be adapted for executing an analytical process and can comprise a detection area and/or an interface to an analyzing apparatus. Microfluidic chips are known in the art and therefore not described in detail.

In other embodiments, different features, in particular different retaining devices, disclosed in different figures can be combined in one microfluidic device.

It is to be understood that the invention as described above is not limited to the particular component parts of the devices described or to process steps of the methods described as such devices and processes may vary. It is also to be understood, that the terminology used herein is for purposes describing particular embodiments only and it is not intended to be limiting. It must be noted that, as used in the specification and the appended claims, the singular forms of “a”, “an”, and “the” include plural referents until the context clearly dictates otherwise. Thus, for example, the reference to “a retaining device” may include two or more such devices; “a flow path” may as well include two or more channels where it is reasonably in the sense of the present invention.

1-39. (canceled)

40. A microfluidic device comprising at least one inlet port, at least one flow path coupled to the inlet port, and at least one fluid separation element coupled to the flow path, wherein the fluid separation element comprises a packing material and is adapted for separating different components of a fluid, wherein the microfluidic device comprises at least one retaining device adapted for retaining the packing material of the fluid separation element.

41. The microfluidic device of claim 40, comprising at least one of:
the retaining device is installed and realized in situ inside the microfluidic device;
the fluid separation element comprises a column with a stationary phase;
the retaining device comprises at least one plug up realizing a microfluidic filter;
the microfluidic device comprises an opening, in particular realizing the inlet port, for filling material into the microfluidic device;
the packing material, in particular the stationary phase of the of the column of the fluid separation element, is retained and/or confined by the retaining device for holding it in place inside the microfluidic device.

42. The microfluidic device of claim 40, wherein the flow path, in particular the stationary phase and/or the retaining device, comprises a grained material, preferably in jammed form.

43. The microfluidic device of claim 40, wherein the fluid separation element, in particular the stationary phase of the column, comprises a grained analytical material, and wherein the retaining device, in particular the microfluidic filter, comprises a grained filtering material preferably comprising glass and/or polymeric powder and/or silica gel.

44. The microfluidic device of claim 40, wherein the microfluidic device comprises a porous material with particles adhering to each other.

45. The microfluidic device of claim 41, wherein the particles of the grained material are adhered to each other by a bonding, gluing, heat-treating, irradiation, and/or a chemical-treating process.

46. The microfluidic device of claim 40, wherein the microfluidic device comprises beads having a plurality of components.

47. The microfluidic device of claim 40, wherein the retaining device comprises the beads and components of decomposed beads, in particular adhered to not decomposed beads and/or jammed in between the not decomposed beads.

48. The microfluidic device of claim 40, wherein the flow path comprises at least one narrowing.

49. The microfluidic device of claim 41, comprising at least one of:
the diameter of the flow path is reduced at the narrowing at least to the minimal grain size of the grained material multiplied by 5, in particular by 1, preferably by a value less than 5 and larger than 0.1, in particular by a value less than 3 and larger than 0.5;
the flow path comprises at least two parallel-connected narrowings;
the narrowing is coupled to the column.
the flow path comprises at least two series-connected narrowings, wherein the two narrowings are preferably series-connected via the column.

50. The microfluidic device of claim 40, wherein the flow path comprises a conically formed portion, in particular nearby the opening.

51. The microfluidic device of claim 40, wherein the retaining device comprises at least one microfluidic sieve,
wherein the sieve is realized by at least one of the following features:
a structured-plate having micro-holes, in particular micro-holes with a diameter of more than 1 micron and less than 25 microns,
a porous polyimide,
a sheet-calendered foil.

52. The microfluidic device of claim 40, comprising at least one of:
the sieve is put against the inlet port, in particular the opening, of the microfluidic device;
the sieve is bonded to the microfluidic device.

53. The microfluidic device of claim 40, wherein the retaining device comprises a monolithic in situ polymerized porous material.

54. The microfluidic device of claim 40, comprising at least one of:
the retaining device and the packing material are joined to one functional unit;
the retaining device and the packing material are joined to one functional unit, and the fluid separation element comprises at least one of the following features to keep the in situ polymerized porous material of the retaining device or rather the packing material of the column form-closed in position:
a narrowing;
a curved flow path;
a protrusion.

55. A method for producing a microfluidic device with a retaining device, in particular a microfluidic device according to the claim 40, comprising:
filling grained material through an opening of the microfluidic device into a column of the microfluidic device,
closing the column at least at two end points, and
closing the opening.

56. Method of claim 55, including additionally at least one of the following for changing the condition of the grained material or treating the grained material by
jamming;
bonding;
gluing;
decomposing;
heat-treating;
exposing to radiation;
treating or changing the grained material in situ.

57. A method for producing a microfluidic device with a retaining device, in particular a microfluidic device according to the claim 40 comprising:
filling an analytical material through an opening of the microfluidic device into a column of the microfluidic device,
filling a filtering material, in particular grained polymeric material, preferably Polyetheretherketone, through the opening for closing the column, and
changing at least one of the structure and the state of the filtering material.

58. Method of claim 57, comprising at least one of:
changing at least one of the structure and the state of the filtering material by a photo-polymerization process, in particular by using ultra violet radiation;
changing at least one of the structure and the state of the filtering material, in particular the grained polymeric material, by a thermal treatment;
lowering the melting point of the grained polymeric material at the surface by activating the surface with ultra violet radiation and tempering the activated grained polymeric material at temperatures as low as 100° C., in particular lower as 100° C.

59. A method for producing a microfluidic device with a retaining device, in particular a microfluidic device according to the claim 40, comprising:
filling material comprising porous beads through an opening of the microfluidic device,
decomposing beads near the opening,
adsorbing the components of the decomposed beads to adjoining not decomposed beads for closing the column.

60. Method of claim 59, further comprising decomposing and adsorbing the beads by a chemical and/or thermal treatment, in particular by a thermal treatment induced by an infrared laser.

61. A method for producing a microfluidic device with a retaining device and a fluid separation element, in particular a microfluidic device according to the claim 40, comprising:
filling a mixture of two monomers into the fluid separation element,
starting a polymerization process,
washing out a component of the polymerized mixture.

62. Method of claim 61, further comprising fixing the fluid separation element inside the microfluidic device form-closed.
